(19) United States
(12) Patent Application Publication
(10) Pub. No.: US 2024/0240953 A1
(43) Pub. Date: Jul. 18, 2024

(54) INFORMATION PROCESSING DEVICE

(71) Applicant: TOYOTA JIDOSHA KABUSHIKI KAISHA, Toyota-shi (JP)

(72) Inventor: Akihiko YAMAMURO, Tokyo (JP)

(73) Assignee: TOYOTA JIDOSHA KABUSHIKI KAISHA, Toyota-shi (JP)

(21) Appl. No.: 18/489,432

(22) Filed: Oct. 18, 2023

(30) Foreign Application Priority Data
Jan. 16, 2023 (JP) 2023-004566

(51) Int. Cl. G01C 21/34

(52) U.S. Cl. CPC G01C 21/3492; G06V 20/58

(57) ABSTRACT

The information processing device includes a control unit configured to acquire, from a first vehicle that has turned right at a predetermined intersection, first data relating to a time taken to turn right at the intersection, and calculate, based on the first data, an evaluation value representing smoothness when turning right at the intersection.

### CROSS-REFERENCE TO RELATED APPLICATION

This application claims priority to Japanese Patent Application No. 2023- 004566 filed on Jan. 16, 2023, incorporated herein by reference in its entirety.

### BACKGROUND

### 1. Technical Field

The present disclosure relates to a device for collecting information regarding roads.

### 2. Description of Related Art

Numerous technologies for improving the accuracy of route searching are known. In relation thereto, for example, Japanese Unexamined Patent Application Publication No. 2004-325357 (JP 2004-325357 A) discloses a device that calculates a cost for each road link, and searches for a route taking into consideration characteristics of roads such as width of the roads, whether there are traffic signals, and whether there are right turn lanes.

### SUMMARY

It is an object of the present disclosure to evaluate intersections by smoothness of right turns.

An aspect of an embodiment of the present disclosure is an information processing device including a control unit that executes acquiring, from a first vehicle having turned right at a predetermined intersection, first data relating to time taken when turning right at the intersection, and calculating an evaluation value representing smoothness when turning right at the intersection, based on the first data.

Also, examples of other aspects include a method executed by the above-described device, a program for causing a computer to execute the method, and a computer-readable storage medium storing the program in a non-transitory manner.

According to the present disclosure, intersections can be evaluated by smoothness of right turns.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating components of a vehicle system according to an embodiment;

FIG. 2 is a diagram illustrating a cycle of a signal;

FIG. 3 is an example of right-turn data generated by an in-vehicle device;

FIG. 4 is an example of intersection data generated by a server device;

FIG. 5 is a flowchart of processing executed by the in-vehicle device;

FIG. 6 is a flow chart of a process executed by the in-vehicle device; and

FIG. 7 is a flowchart of processing executed by the server device.

### DETAILED DESCRIPTION OF EMBODIMENTS

There is known an apparatus that performs route search by estimating a time required for passage for each road link based on information collected from a probe car.

However, in the conventional route search apparatus, although the estimated passage time can be calculated for each road link, the intersection is not evaluated from the viewpoint of “whether or not it is easy to bend across the oncoming lane”.

The following embodiments assume a country or region in which the vehicle is on the left side.

In the case of left side traffic, a vehicle turning right at an intersection needs to cross the oncoming lane.

For example, there are intersections where the traffic volume of the oncoming lane is high and it is difficult to turn right while the blue signal is on. In such an intersection, a right turn dedicated signal may be provided, but in a case where the traffic volume of the right turn is large, in some cases, all the vehicles waiting for the right turn cannot turn right within the time. As described above, there is a case where there is an intersection that takes a particularly long time for a right turn compared to a straight turn or a left turn. In the conventional route searching device, since only the actual passing time in the road link is taken into consideration, there is a problem that it is not possible to accurately estimate the time cost required for a right turn.

For example, consider a case where there is a road link toward a certain intersection. This intersection is assumed to be an intersection where a straight-ahead vehicle occupying 90% can smoothly pass, but a right-turn vehicle occupying 10% cannot smoothly turn right. In this case, since the cost allocation to the road link is performed according to the passage record of the straight-traveling vehicle which occupies the majority, the road link is determined to be a road link having a low cost (a short passage expected time). In such a situation, when a vehicle requiring a right turn is guided to the intersection, more waiting time than expected occurs.

The information processing device of the present disclosure solves such problems.

An information processing device according to an aspect of the present disclosure includes a control unit configured to acquire, from a first vehicle that has turned right at a predetermined intersection, first data relating to a time taken to turn right at the intersection, and calculate an evaluation value representing smoothness when turning right at the intersection based on the first data.

The first vehicle transmits the first data to the information processing device when the predetermined intersection is turned right. The first data is data related to the time taken to turn right at the intersection, and typically includes the time from the start of the right turn operation of the first vehicle until the completion of the right turn, cycle information of the traffic signal installed at the intersection, the traffic volume in the oncoming lane, or the traffic congestion situation on the road at the right turn destination. The cycle information is information about a time at which each of the plurality of lights included in the traffic light is turned on.

These data may be measured or acquired by the first vehicle.

Based on the first data, the control unit evaluates the intersection of the object from the viewpoint of “whether the right turn can be smoothly performed”, and generates an evaluation value.

The evaluation value can take a larger value as the value is an intersection at which the right turn can be smoothly performed. For example, the evaluation value may be made larger as the period in which the right turn is possible is longer. Further, for example, the evaluation value may be made larger as the average value of the times required for the right turn is shorter.
According to this configuration, it is possible to identify an intersection where a right turn cannot be smoothly performed.

The control unit may calculate an evaluation value for each of the plurality of intersections based on the plurality of first data for each of the plurality of intersections acquired from the plurality of first vehicles.

For example, it is expected that an appropriate route can be generated by performing evaluation on each of a plurality of intersections included in the target range of the route search.

The control unit may generate second data in which each of the plurality of intersections is associated with a corresponding evaluation value. The control unit may transmit the second data to the first vehicle. When the first vehicle has a terminal having a route searching function, route searching or the like can be performed based on the second data.

Further, the information processing device may provide the route search function by using the second data. In this case, when there is a request from the first vehicle, the information processing device may perform a route search based on the second data and provide the result to the first vehicle.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### FIRST EMBODIMENT

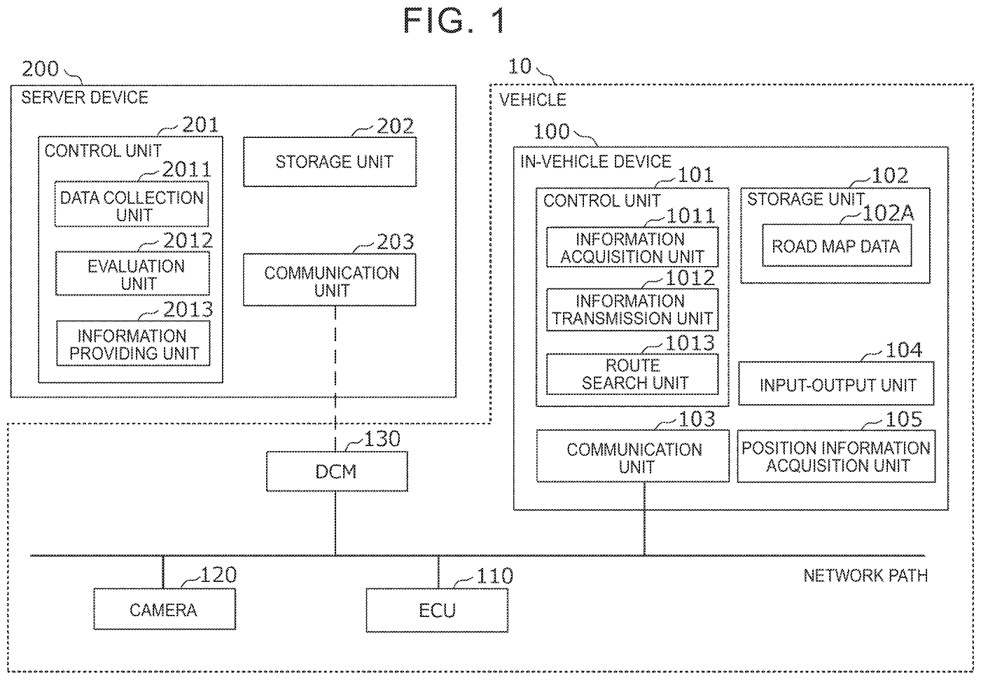

An outline of a vehicle system according to a first embodiment will be described with reference to FIG. 1. The vehicle system according to the present embodiment includes a vehicle 10 on which the in-vehicle device 100 is mounted, and a server device 200. A plurality of vehicles 10 (and in-vehicle devices 100) may be included in the vehicle system.

When a predetermined intersection is turned right during traveling, the in-vehicle device 100 acquires data for evaluating the right turn and transmits the data to the server device 200. A given intersection is typically an intersection with an oncoming lane and a traffic light. In the following description, the data generated and transmitted by the in-vehicle device 100 is referred to as “right turn data (first data)”.

The right turn data includes a plurality of pieces of data for causing the server device 200 to evaluate the degree of smoothness in passing through the intersection. The details will be described later.

The server device 200 calculates an evaluation value indicating how smoothly the vehicle can turn right on the basis of the right turn data received from the plurality of vehicles 10 (in-vehicle devices 100), and stores the evaluation value in association with the target intersection. The evaluation value may be calculated by performing statistical processing on a plurality of right turn data. The data in which the evaluation value is associated with the intersection is referred to as “intersection data (second data)”.

The intersection data is transmitted from the server device 200 to the in-vehicle device 100 in response to the request, and is used for route search.

Each element of the system will be described in detail.

The vehicle 10 according to the present embodiment includes an in-vehicle device 100, an ECU 110, a camera 120, and a DCM 130.

First, ECU 110 will be described.

ECU 110 is an electronic control unit that controls a plurality of components of the vehicles 10. ECU 110 has a function of periodically communicating with a plurality of components via an in-vehicle network. In the present embodiment, a vehicle speed sensor and a winker sensor are exemplified as components of the vehicle 10.
The vehicle speed sensor is a sensor that senses the speed of the vehicle 10. The winker sensor is a sensor that senses an operation state of the winker included in the vehicle 10.

ECU 110 can be configured as a computer having a processor such as a CPU or a GPU, a main storage device such as a RAM or a ROM, and a secondary storage device such as a EPROM, a disk drive, or a removable medium.

Note that there may be a plurality of ECU included in the vehicles 10. The plurality of ECU may control components of the respective systems, such as an engine- system, an electrical system, a powertrain system, and an autonomous driving system.

The camera 120 is an in-vehicle camera mounted facing the front of the vehicle 10. The camera 120 can acquire an image capturing the front of the vehicle at a predetermined frame rate. The images acquired by the camera 120 are used by a plurality of components included in the vehicles 10, such as the in-vehicle device 100 and ECU of the automated driving system.

A DCM 130 is a device that wirelessly communicates with another device (or an external network) over a network. DCM 130 functions as a gateway for connecting components of the vehicle 10 to a network outside the vehicle. For example, DCM 130 provides the in-vehicle device 100 with access to an external network. Thus, the in-vehicle device 100 can communicate with the external device via DCM 130.

DCM 130 may also provide access to the external network-not limited to a predetermined ECU (ECU 110 of vehicles 10).

Next, the in-vehicle device 100 will be described.

The in-vehicle device 100 is a device (for example, a car navigation device) that provides information to an occupant of the vehicle. The in-vehicle device 100 is also called a car navigation device, an infotainment device, or a head unit. The in-vehicle device 100 can provide navigation and amusement to the occupant of the vehicle.
The in-vehicle device 100 has a function of performing radio communication with an external network via a DCM 130 described later. The in-vehicle device 100 may have a function of downloading traffic information, road map data, music, moving images, and the like by communicating with an external network of the vehicle 10. In addition, the in-vehicle device 100 may be a device that can cooperate with a smartphone or the like.

The in-vehicle device 100 can be configured as a computer including a processor such as a CPU and a GPU, a main storage device such as a RAM and a ROM, and an auxiliary storage device such as a EPROM, a hard disk drive, and a removable medium. An operating system (OS), various programs, various tables, and the like are stored in the auxiliary storage device. The programs stored in the auxiliary storage device are executed such that various functions can be implemented that match the predetermined purpose, which will be described below. However, some or all of the functions may be implemented by a hardware circuit such as an ASIC or an FPGA.

The in-vehicle device 100 includes a control unit 101, a storage unit 102, a communication unit 103, an input-output unit 104, and a position information acquisition unit 105.

The control unit 101 is an arithmetic unit that realizes various functions of the in-vehicle device 100 by executing a predetermined program. The control unit 101 may be implemented by, for example, a CPU.

The control unit 101 includes three functional modules: an information acquisition unit 1011, an information transmission unit 1012, and a route search unit 1013. Each functional module may be implemented by execution of a stored program by the CPU.

The information acquisition unit 1011 determines that the vehicle 10 has turned right at an intersection having a traffic light, and generates data (right turn data) related to the right turn.

The fact that the vehicle 10 turns right at an intersection with a traffic light can be determined based on the position information of the vehicle 10, the winker information of the vehicle 10, an image acquired by the camera 120, and the like.

In the present embodiment, the information acquisition unit 1011 measures or acquires the following information, and generates right-turn data including these data.
Information about the time taken to turn right
Signal cycle information
Existence of right turn signal
Traffic volume information on the oncoming lane
Information on traffic congestion at the right-turn destination
   These are examples of “first data regarding the time taken to turn the intersection right”. The right turn data may include any one of the above. Further, other elements may be included as long as they affect the time required for the right turn.

In the following description, “blue light” means a light capable of turning right, and does not give priority to turning right. In the blue signal, the traffic of the oncoming lane is not interrupted. That is, even a blue signal may not turn right depending on the situation of the oncoming lane.

“Right turn signal” means a light that can turn right in preference. In the case of Japan, the arrow type traffic light for right turn corresponds to this. While the right turn signal is on, the traffic in the oncoming lane is interrupted, and the right turn can be freely performed. Incidentally, the light for which right turn is prioritized is a “right turn signal” regardless of the travelable direction. For example, traffic in the oncoming lane is interrupted, and a light that can travel in all directions becomes a “right turn signal”.

“Red signal” means a light that cannot turn right. Lights of signals that are only allowed to travel straight and/or turn left are also included.

The time required for the right turn can be, for example, the time (in seconds) from when the vehicle 10 starts the operation for the right turn until the right turn is completed.

Normally, if there is no particular problem at the intersection, a right turn is completed within a period of time (signal cycle) in which the lights go round. On the other hand, if there is some problem at the intersection, the right turn may not be completed within a single signal cycle.
Therefore, the smoothness of the right turn can be evaluated by including the time required for the right turn in the right turn data.

The fact that the vehicle 10 has started the operation for the right turn and the fact that the right turn has been completed can be determined based on, for example, the position information, the speed information, the information obtained from the image acquired by the camera 120, the winker information, or the like of the vehicle 10.

The time required for a right turn may be expressed in seconds, or may be expressed by a point representing the length of time required for a right turn, or the like. The time required for the right turn may be a time taken for the vehicle 10 to complete the right turn after starting the operation for the right turn.

In the present embodiment, the in-vehicle device 100 calculates, for each intersection, a point representing a time required for a right turn by the depreciation method. Specifically, the in-vehicle device 100 sets an initial point at a timing at which an operation for turning right is started, and subtracts the point every time the light of the signal changes a predetermined number of times. For example, 100 points are set as an initial point, and 10 points are subtracted every time the light of the signal changes a predetermined number of times. If the point is 100 points, it represents that a right turn could be made without waiting time.

The cycle information is information representing the lighting time of each of the lights included in the signal by time (for example, number of seconds).

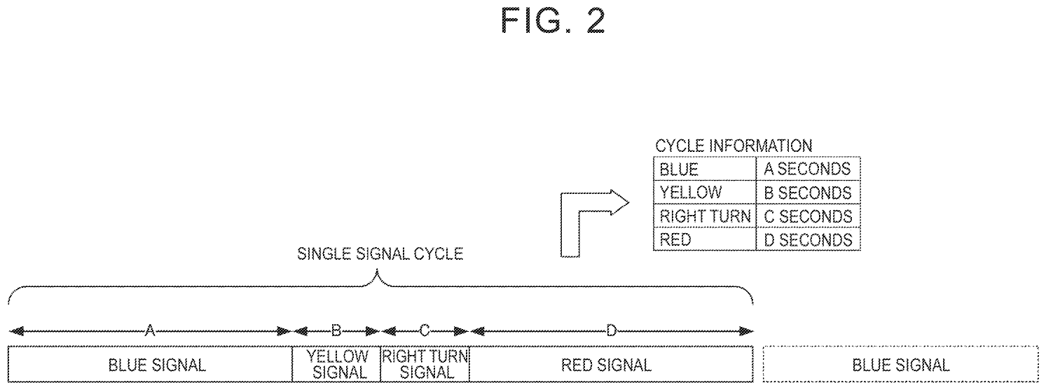

FIG. 2 is a diagram illustrating an example of a signal cycle. In the present example, it is assumed that the lights are turned on in the order of a blue signal, a yellow signal, a right turn signal, and a red signal.
In the figure, A is the lighting time of the blue signal, and B is the lighting time of the yellow signal. Similarly, C is the lighting time of the right turn signal, and D is the lighting time of the red signal. The sum of A, B, C, D represents the cycle of the whole signal.

If the cycle of the signal is not set properly, it may take time to turn right. For example, if there is no right turn signal or the right turn signal is turned on for a short period of time, many cars cannot turn right at one time, and the right turn car may stay near the intersection. Therefore, the smoothness of the right turn can be evaluated by including the cycle information in the right turn data.

The lighting time of each light can be determined by, for example, analyzing the image acquired by the camera 120 over time. Alternatively, the cycle information of the signal may be directly received from the roadside device installed at the intersection.
Note that the cycle information may be information about all the lights as shown in A to D of FIG. 2, or may be information about the lengths of individual lights as shown in “the number of seconds of the blue signal” and “the number of seconds of the right turn signal”.

In addition, when the traffic volume of the oncoming lane is large with respect to the traffic volume that turns right, the right-turning vehicle may not pass unless the right-turning signal is turned on (that is, unless the traffic of the oncoming lane is stopped). On the other hand, when the traffic volume of the oncoming lane is small with respect to the traffic volume that turns right, a right turn can be performed in a period in which the blue signal is lit. Therefore, it is possible to evaluate the smoothness of the right turn by including, in the right turn data, data related to the traffic amount of the oncoming lane.

The traffic volume of the oncoming lane can be determined, for example, by analyzing an image acquired by the camera 120. Alternatively, data regarding the traffic volume of the corresponding road segment (road segment in the oncoming lane) may be received from the server device that manages the traffic information.

Further, when the road at the right turn destination is congested and there is no space for the vehicle to enter, even if there is no problem in the situation of the signal or the oncoming lane, the right turn cannot be performed in some cases. Therefore, it is possible to evaluate the smoothness of the right turn by including, in the right turn data, data relating to the congestion state of the road at the right turn destination.

The traffic jam situation of the road at the right turn destination can be determined by analyzing the image acquired by the camera 120, for example. Alternatively, data regarding the traffic volume of the corresponding road segment (the road segment at the right turn destination) may be received from the server device that manages the traffic information.

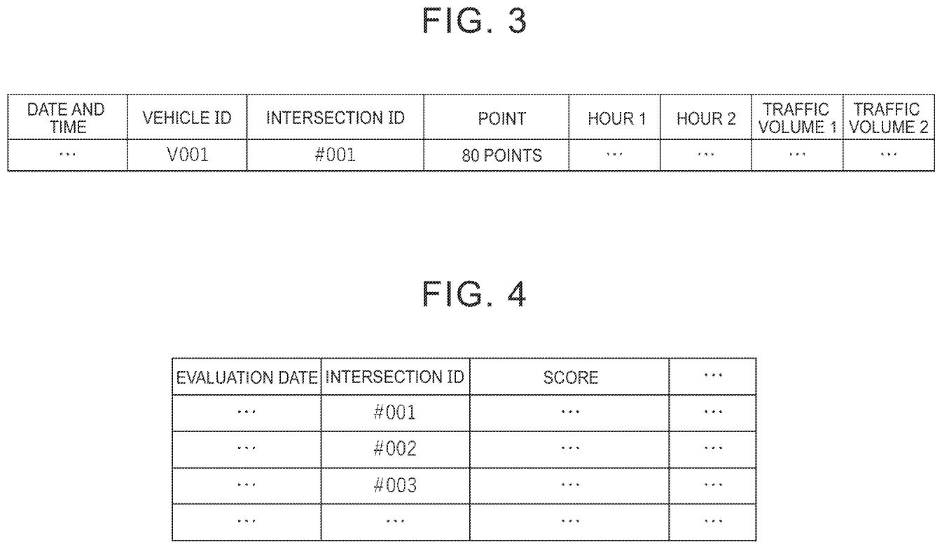

The information transmission unit 1012 transmits the right turn data generated by the information acquisition unit 1011 to the server device 200. The right turn data is generated and transmitted each time the vehicle 10 turns right at the intersection. FIG. 3 is an example of right-turn data generated by the information acquisition unit 1011 and transmitted by the information transmission unit 1012. As shown in the figure, the right turn data is configured with the following fields: date and time, vehicle ID, intersection ID, points, hours 1, hours 2, traffic volume 1, and traffic volume 2.

In the date and time field, the date and time information in which the right turn data is generated is stored. A unique identifier is stored in the vehicle 10 in the vehicle ID field. A unique identifier is stored in the intersection ID field at the intersection where the vehicles 10 have passed. The intersection ID may be defined by the roadmap.

In the point field, a value representing the time taken for the right turn by the point as described above is stored.

In the time field, information about the lighting time of the lights of the traffic light is stored. In the present embodiment, a value representing the lighting time of the blue signal (the length of A in FIG. 2) is stored in “time 1”, and a value representing the lighting time of the right turn signal (the length of C in FIG. 2) is stored in “time 2”.

In the traffic amount information field, information on the traffic amount of the oncoming lane (traffic amount 1) and information on the traffic jam state of the right turn destination (traffic amount 2) are stored. In the present embodiment, a value representing the number of vehicles passing per unit time is stored in the “traffic amount 1”, and a value representing either “congested” or “not congested” is stored in the “traffic amount 2”.

The route search unit 1013 performs route search based on the intersection data generated by the server device 200.

The route search unit 1013 transmits data (hereinafter referred to as request data) requesting the server device 200 to provide intersection data at an arbitrary timing, and receives the intersection data transmitted from the server device 200.
The right-turn data is data collected at a single intersection, while the intersection data is data including scores (values representing the smoothness of the right-turn) of the plurality of intersections evaluated based on the plurality of right-turn data.
When a right turn occurs on a route, the route search unit 1013 searches for a route in consideration of a score included in the intersection data (in other words, using smoothness of the right turn as a cost).

The storage unit 102 is means for storing information, and is composed of a storage medium such as a RAM, a magnetic disk, or a flash memory. The storage unit 102 stores various programs executed by the control unit 101, data used by the programs, and the like. In addition, the storage unit 102 stores road map data 102A.

The road map data 102A is map data of a road on which the vehicles 10 can travel. The road map data 102A may include a road segment-definition.

The communication unit 103 is a communication interface for connecting the in-vehicle device 100 to a bus of an in-vehicle network. The communication unit 103 may include interfaces for performing Controller Area Network (CAN) communication in vehicles.

The input-output unit 104 is means for receiving the input operation performed by the user and presenting information to the user. Specifically, the input-output unit 104 includes a touch panel, a control unit for the touch panel, a liquid crystal display, and a control unit for the liquid crystal display. The touch panel and the liquid crystal display are composed of one touch panel display in the present embodiment. The input-output unit 104 may include a unit (amplifier or speaker) for outputting the sound, a unit (microphone) for inputting the sound, etc.

The position information acquisition unit 105 acquires the position information of the vehicle 10, and identifies the road segment on which the vehicle 10 is traveling. The position information acquisition unit 105 includes GPS antennae and positioning modules for positioning the position information. The GPS antenna is an antenna that receives a positioning signal sent from a positioning satellite (also referred to as a global navigation satellite system (GNSS) satellite). The positioning module is a module that calculates the position information based on a signal received by the GPS antenna.

Next, the server device 200 will be described.

The server device 200 performs a process of collecting right-turn data from a plurality of vehicles 10 (in-vehicle devices 100) and storing the right-turn data in a database, and a process of assigning a score to a plurality of intersections based on the collected right-turn data. The score is a value representing the degree of smooth right-turn.

The server device 200 can be configured as a computer having a processor such as a CPU or a GPU, a main storage device such as a RAM or a ROM, an auxiliary storage device such as an EPROM, a hard disk drive, and a removable medium. The secondary storage device stores an operating system (OS), various programs, various tables, and the like. The program stored in the auxiliary storage device is loaded into a work area of the main storage device and executed, and the constituent units and the like are controlled through the execution of the program, so that each function matching a predetermined purpose can be realized, as will be described later. However, some or all of the functions may be implemented by a hardware circuit such as an ASIC or an FPGA.

The server device 200 includes a control unit 201, a storage unit 202, and a communication unit 203.

The control unit 201 is an arithmetic device that governs the control performed by the server device 200. The control unit 201 can be realized by an arithmetic processing device such as a CPU.
The control unit 201 includes a data collection unit 2011, an evaluation unit 2012, and an information providing unit 2013 as functional modules. Each functional module may be implemented by execution of a stored program by the CPU.

The data collection unit 2011 performs a process of collecting right-turn data from a plurality of vehicles 10 (in-vehicle devices 100) and storing the right-turn data in a storage unit 202 to be described later. The right-turn data described with reference to FIG. 3 is accumulated in the storage unit 202.

The evaluation unit 2012 calculates a score for each of the plurality of intersections based on the plurality of right turn data accumulated in the storage unit 202. The evaluation unit 2012 executes a score calculation process at a predetermined cycle. As described above, the score can be set to a value that becomes higher as a smooth right turn is possible. The evaluation unit 2012 statistically processes a plurality of right turn data (elements illustrated in FIG. 3) transmitted from a plurality of vehicles for each intersection, and calculates a score.

For example, a higher score is calculated for intersections where the points are higher, the blue signal time is longer, there is a right turn signal, the right turn signal time is longer, the oncoming lane traffic is smaller, and there is a tendency for no congestion to occur at the right turn.

Also, a lower score is calculated for intersections where the points are lower, the time of the blue signal is shorter, there is no right turn signal, the time of the right turn signal is shorter, the traffic volume of the oncoming lane is larger, and the vehicle tends to be congested at the right turn destination.

The calculated score is associated with the intersection and stored as intersection data. FIG. 4 is an example of intersection data.

When the traffic situation (easiness of turning right) changes depending on the day of the week or the time zone, the score may be calculated and held according to the day of the week or the time zone.

The storage unit 202 includes a main storage device and an auxiliary storage device. The main storage device is a memory in which a program executed by the control unit 201 and data used by the control program are expanded. The auxiliary storage device is a device in which a program executed by the control unit 201 and data used by the control program are stored.

Further, the storage unit 202 stores right turn data collected from the plurality of vehicles 10 and generated intersection data.

The communication unit 203 is a communication interface for connecting the server device 200 to a network. The communication unit 203 includes, for example, a network interface board and a wireless communication interface for wireless communication.

The configuration shown in FIG. 2 is an example, and all or a part of the functions shown in FIG. 2 may be executed using a specially designed circuit. Further, a program may be stored or executed by a combination of the main storage device and the auxiliary storage device other than the functions shown in FIG. 2.

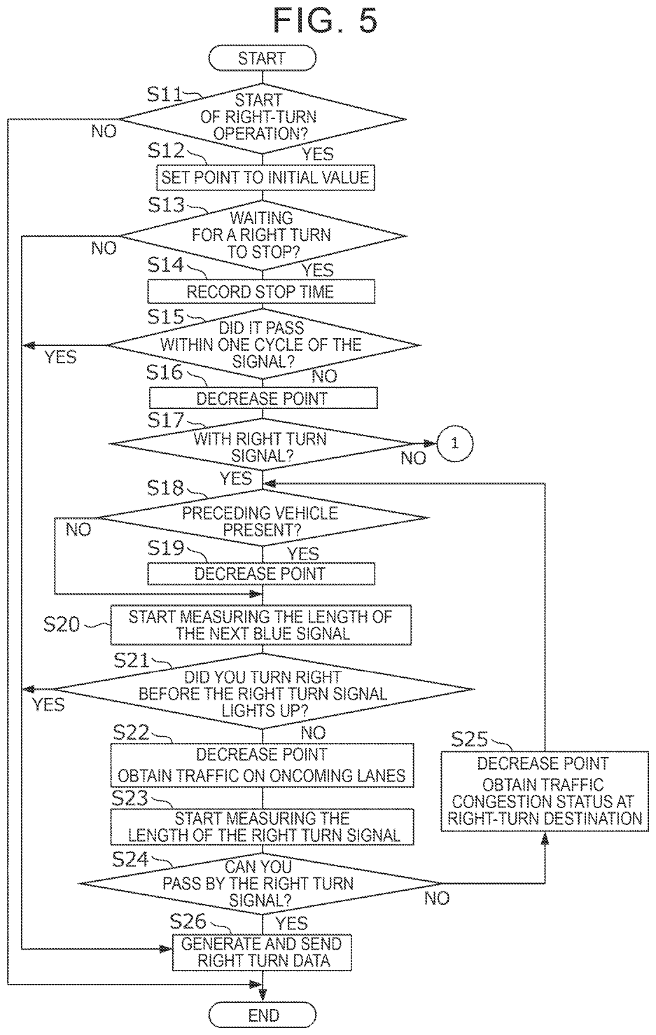

Next, specific contents of processing performed by the in-vehicle device 100 will be described. FIG. 5 is a flowchart of processing executed by the in-vehicle device 100. The illustrated processing is repeatedly executed while the vehicle 10 is traveling.

First, in S11, the information acquisition unit 1011 determines whether or not the host vehicle has started an operation for turning right. The operation for right turn is typically an operation of turning on the right winker while slowly running in the vicinity of the intersection.

In this step, an affirmative determination is made when a condition such as “the own vehicle is in the vicinity of the intersection”, “the speed is equal to or less than the predetermined value”, or “the right winker is lit” is satisfied. Whether or not these conditions are satisfied may be determined based on information acquired from the position information acquisition unit 105 or ECU 110.
If an affirmative determination is made in this step, the process proceeds to S12. When the determination result is No in this step, the process is terminated.

Next, in S12, the information acquisition unit 1011 sets the point to the default value. If the point ranges from 0 to 100 points, the initial value of the point is 100 points. The point is a numerical value that decreases as time is taken to pass (turn right) the intersection.

Next, in S13, the information acquisition unit 1011 determines whether or not the host vehicle is stopping for waiting for a right turn. In this step, an affirmative determination is made when a condition such as “the own vehicle is in the vicinity of the intersection”, “the speed is 0”, and “the right winker is lit” is satisfied. Whether or not these conditions are satisfied may be determined based on information acquired from the position information acquisition unit 105 or ECU 110.

If an affirmative determination is made in this step, the process proceeds to S14.
If the right turn is completed without the speed being 0, the determination in this step is negative. If a negative determination is made in this step, this means that the host vehicle could turn right without stopping. In this case, the process transitions to S26 to generate right-turn data including the present point, and the information transmission unit 1012 transmits the right-turn data to the server device 200. In this case, the points included in the right turn data are 100 points.

Next, in S14, the information acquisition unit 1011 records the time at which the host vehicle has stopped. This time serves as a calculation start point of the time during which the vehicle 10 is waiting for a right turn.

Next, in S15, the information acquisition unit 1011 determines whether or not a right turn has been made within one cycle. For example, when a right turn is made within a period in which a light capable of turning right is turned on after the vehicle 10 stops, the present step is determined to be affirmative. If a right turn cannot be made within a period in which a light capable of turning right is turned on, and then a light that cannot proceed in any direction is turned on, the present step is determined to be negative.

If a negative determination is made in this step, the process proceeds to S16.
If an affirmative determination is made in this step, this means that the vehicle 10 is able to smoothly turn right. In this case, the process transitions to S26 to generate right-turn data including the present point, and the information transmission unit 1012 transmits the right-turn data to the server device 200. In this case, the points included in the right turn data are 100 points. Note that the right turn data may include the measured waiting time in addition to the points.

When the process transitions to S16, the lights that can turn right are turned on, but this means that the right turn could not be made for some reason. Therefore, in S16, the point is decremented by a predetermined value. Thus, for example, the point of 100 points is subtracted to 90 points.

The process after S17 differs depending on whether or not a right turn signal is installed at the intersection of the object.

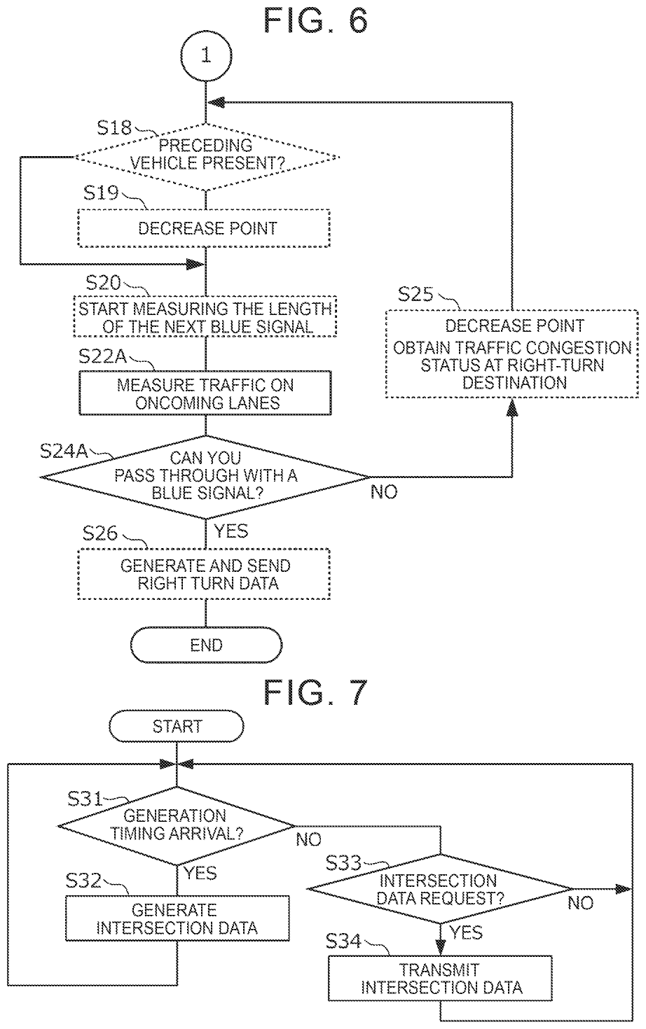

First, a case where a right turn signal is installed at an intersection of a target will be described. S18˜S26 process is executed when the right turn signal is installed at the intersection of the object. Processing in the case where the right turn signal is not installed at the intersection of the object will be described later with reference to FIG. 6. Whether or not the right turn signal is installed at the intersection of the object can be determined based on, for example, an image acquired by the camera 120.

In S18, the information acquisition unit 1011 determines whether or not there is a preceding vehicle in front of the host vehicle. The presence of the preceding vehicle can be determined based on, for example, an image acquired by the camera 120 or information output by a sensor included in the vehicle 10. If there are preceding vehicles, the process transitions to S19. When there is no preceding vehicle, that is, when the host vehicle is at the head of the right turn waiting state, the process transitions to S20.

When the vehicle transitions to S19, this means that the vehicle cannot turn right while the light capable of turning right is on is present in addition to the host vehicle. Therefore, in S19, the point is decremented by a predetermined value.

In S20, the measurement of the length of the subsequent blue signal is started. The light of the signal can be determined, for example, based on an image acquired by the camera 120.

In S21, the information acquisition unit 1011 determines whether or not the subject vehicle can turn right before the right turn signal is turned on. If the subject vehicle is able to turn right before the right turn signal is turned on, the process transitions to S26, and the information transmission unit 1012 transmits the right turn data to the server device 200. In addition to the present point, the right turn data may include information about the length of the blue signal at which the measurement is started by S20.

When the right turn signal is lit, the process transitions to S22.

Transitioning to S22 means that the oncoming lane has a lot of traffic and cannot turn right while the blue light is on. Therefore, in S22, the point is decremented by a predetermined value, and the traffic volume of the oncoming lane is measured. The traffic volume of the oncoming lane can be determined by analyzing the images acquired by the camera 120 back and forth over time.

In S23, the information acquisition unit 1011 starts measuring the length of the right turn signal.

In S24, the information acquisition unit 1011 determines whether or not the subject vehicle can turn right while the right turn signal is turned on. If the subject vehicle is able to turn right while the right turn signal is on, the process transitions to S26, and the information transmission unit 1012 transmits the right turn data to the server device 200. The right turn data may include, in addition to the present point, information on the length of the blue signal, which is measured by S20, information on the traffic volume of the oncoming lane, which is acquired by S22, and information on the length of the right turn signal, which is measured by S23.

If the subject vehicle cannot turn right while the right turn signal is lit, the process transitions to S25.

In S25, the point is further decremented by a predetermined value, and the process transitions to S18. In this way, if a right turn cannot be made while the blue or right turn signal is on, the steps from S18 are repeatedly executed and the points are repeatedly decremented.

In addition, S25 acquires the congestion status (“congested” or “not congested”) in the road segment of the right-turn destination. The congestion situation in the road segment at the right turn destination can be determined by analyzing the image acquired by the camera 120. The acquired traffic jam status is included in the right turn data, and is transmitted to the server device 200 after the right turn is completed.

FIG. 6 is a flowchart of processing executed by the in-vehicle device 100 in a case where a right turn signal does not exist at the intersection of the object. The process up to S20 is the same as that shown in FIG. 5.

S22A measures the traffic volume in the oncoming lane. The traffic volume of the oncoming lane can be determined by analyzing the images acquired by the camera 120 over time.

Next, in S24A, the information acquisition unit 1011 determines whether or not the subject vehicle has turned right within the time period in which the blue signal is turned on. If the subject vehicle is able to turn right within the period in which the blue signal is lit, the process transitions to S26, and the information transmission unit 1012 transmits the right turn data to the server device 200. In addition to the points, the right turn data may include information about the length of the blue signal at which the measurement is started by S20.

If the own vehicle cannot turn right within the time period in which the blue signal is lit, the process transitions to S25. That is, as described with respect to FIG. 5, when the user cannot turn right while the blue signal is on, the steps from S18 are repeatedly executed and the points are repeatedly decremented.

FIG. 7 is a flowchart of processing (intersection data generation processing) executed by the server device 200. It is assumed that the right turn data is received each time from the in-vehicle device 100 by the data collection unit 2011 and stored in the storage unit 202.

First, in S31, the evaluation unit 2012 determines whether or not the generation timing of the intersection data has arrived. The generation timing of the intersection data may arrive at a predetermined cycle.

When the generation timing of the intersection data arrives, the process transitions to S32, and the evaluation unit 2012 generates the intersection data.

The evaluation unit 2012 statistically processes the elements shown in FIG. 3 using unprocessed right turn data or right turn data generated within a predetermined period of the past, and calculates a score for each intersection. The calculated score is associated with the intersection and stored as intersection data.

In S31, when the generation timing of the intersection data has not arrived, the process transitions to S33, and it is determined whether or not the request data (the transmission request for the intersection data) has been received from the in-vehicle device 100. Here, when the request data is received from the in-vehicle device 100, the process transitions to S34, and the latest intersection data is transmitted to the in-vehicle device 100 that has transmitted the request data. Incidentally, the intersection data may be data for all intersections under management, or data for intersections existing within a predetermined range from the vehicle 10.

The in-vehicle device 100 performs a route search using the received intersection data, and outputs the result. As described with reference to FIG. 4, the score associated with each intersection represents the ease of right turn at the intersection. When a right turn occurs in the route search, an appropriate route can be generated by using a score associated with the intersection as a cost required for passing.

As described above, in the vehicle system according to the present embodiment, each of the plurality of vehicles 10 generates data (right turn data) for evaluating how smoothly the right turn is performed when the right turn is performed at the intersection, and transmits the data to the server device 200. The server device 200 evaluates the intersection based on the plurality of collected right-turn data, and transmits the intersection data including the result to the in-vehicle device 100 in response to the request. According to such a configuration, the in-vehicle device 100 can identify an intersection capable of a smooth right turn, and can generate a more appropriate route.

### MODIFICATION OF THE FIRST EMBODIMENT

In the first embodiment where, the server device 200 provides the intersection data to the in-vehicle device 100, and the in-vehicle device 100 performs the route search, but the server device 200 may have the route search function.

In this case, the server device 200 may search for a route connecting the departure point and the destination based on the request received from the in-vehicle device 100, and notify the in-vehicle device 100 of the result. The server device 200 searches for a route by using a score included in the generated intersection data as a passing cost when the intersection is turned right.
Even with such a configuration, an appropriate path can be generated in consideration of the cost at the time of right turn.

### MODIFIED EXAMPLES

The above embodiments are merely exemplary, and the present disclosure can be appropriately modified without departing from the gist thereof.

For example, the processes and means described in the present disclosure can be freely combined and implemented as long as no technical contradiction occurs.

Although FIG. 3 is illustrated as right turn data in the description of the embodiment, other data may be acquired and transmitted as long as the data is used to evaluate the smoothness of the right turn. The score calculation method executed by the evaluation unit 2012 is not limited to the example.

Further, in the description of the embodiment, an example in which the route search is performed based on the intersection data has been described, but the intersection data may be used for applications other than the route search. For example, in a case where the intersection where the right turn cannot be smoothly performed is located in front of the own vehicle, the in-vehicle device 100 may overlay display a graphic or the like indicating the intersection on the road map. In addition, when the driver attempts to turn right at the intersection, the notification may be output by an image or sound. The notification may include an expected waiting time or the like.

Further, although the description of the embodiment assumes the country or region of the left side passage, in the case of the country or region of the right side passage, “right turn” in the present specification may be read as “left turn”.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, hard disk drive (HDD), etc.), an optical disc (compact disc (CD)-read-only memory (ROM), digital versatile disc (DVD), Blu-ray disc, etc.), a ROM, a random access memory (RAM), an erasable programmable read only memory (EPROM), an electrically erasable programmable read only memory (EEPROM), a magnetic card, a flash memory, an optical card, and any type of medium suitable for storing electronic commands.

What is claimed is:

1. An information processing device, comprising: a control unit that executes
acquiring, from a first vehicle having turned right at a predetermined intersection, first data relating to time taken when turning right at the intersection, and
calculating an evaluation value representing smoothness when turning right at the intersection, based on the first data.

2. The information processing device according to claim 1, wherein the first data includes at least one of a time period from the first vehicle starting a right turn operation until the right turn is completed, cycle information of a traffic signal installed at the intersection, traffic volume in a lane opposite to the first vehicle, and traffic congestion conditions on a road onto which the first vehicle turned right.

3. The information processing device according to claim 1, wherein the control unit calculates the evaluation value for each of a plurality of the intersections based on a plurality of the first data for each of the intersections acquired from a plurality of the first vehicles.

4. The information processing device according to claim 3, wherein the control unit transmits, to the first vehicle, second data in which each of the intersections is associated with a corresponding one of the evaluation values.

5. The information processing device according to claim 3, wherein the control unit generates second data in which each of the intersections is associated with a corresponding one of the evaluation values, and performs route search based on the second data when a request is made by the first vehicle.
